(19) United States
(12) Patent Application Publication
(10) Pub. No.: US 2015/0193376 A1
(43) Pub. Date: Jul. 9, 2015

(54) METHOD OF MULTI-SCALES INTRINSIC ENTROPY ANALYSIS

(71) Applicant: National Central University, Jhongli City (TW)

(72) Inventors: Jia-Rong YEH, Jhongli City (TW); Norden E. HUANG, Jhongli City (TW); Men-Tzung LO, Jhongli City (TW); Chung-Kang PENG, Sharon, MA (US)

(73) Assignee: National Central University, Jhongli City (TW)

(21) Appl. No.: 14/245,431

(22) Filed: Apr. 4, 2014

(30) Foreign Application Priority Data
Jan. 6, 2014 (TW) 103100339

(51) Int. Cl. G06F 17/10

(52) U.S. Cl. CPC G06F 17/10

(57) ABSTRACT

This invention discloses a multi-scales intrinsic entropy analysis method that can quantify the entropies on difference time scales for a complex time series. The implementation of the method decomposes a complex time series into a plurality of intrinsic mode functions by a nonlinear signal processing algorithm, such as the method of empirical mode decomposition. Then, the entropy increments can be calculated on multiple coarse-graining scales when an intrinsic mode functions is added into the reconstructed time series analyzed by the method of multi-scale entropy. The entropy increment is significant on a specific coarse-graining scale, which corresponds to the averaged period of the intrinsic mode functions. The entropy increment on the specific coarse-graining scale is defined as the intrinsic entropy for an intrinsic mode functions. Multiple intrinsic entropies represent the entropy properties for a complex time series on their corresponding time scales.

### CROSS-REFERENCE TO RELATED APPLICATIONS

This Non-provisional application claims priority under 35 U.S.C. §119(a) on Patent Application No(s). [103100339] filed in Taiwan, Republic of China [Jan. 6, 2014], the entire contents of which are hereby incorporated by reference.

### FIELD OF THE INVENTION

The invention relates to an analysis method and, more particularly, to an entropy analysis method.

### BACKGROUND OF THE INVENTION

Entropy is a complexity physical description of the dynamic system. In important areas of control theory, probability theory, number theory, astrophysics, life sciences, the characteristics of the performance of the entropy value or amount of change are often used to represent the dynamic characteristics of the system. Although the conventional evaluation methods of entropy, such as approximate entropy and sample entropy can use an entropy value to represent the performance of the overall entropy characteristics of complex systems, the entropy does not just represent the macroscopic characteristics of the complex systems. For a complex system with a limited number of different time scales of regulatory mechanisms, the dynamic characteristics at different time scales may be different. Because the existing evaluation methods of entropy can not determine the dynamic characteristics of a complex system at different scales via a single entropy value, it is important to develop an appropriate entropy analysis method.

The present research in related fields, such as the U.S. patent case U.S. 61/195,894 and U.S. Ser. No. 12/411,539, use methods of empirical mode decomposition (EMD) and Hilbert-Huang spectral analysis (HSA) to provide a time-frequency analysis. The method of EMD can decompose a time sequence signal to a plurality of intrinsic mode functions, and the processes are as follows: (1) All limit values are identified in the time sequence signal, and all maximum values are connected with each adjacent other to form as an upper envelope, and all minimum values are connected with each adjacent other to form as a lower envelope via a cubic spline. (2) A data is subtracted from an average envelope of the upper envelope and the lower envelope to obtain a first measure of weight. (3) The steps (1) and the step (2) are executed repeatedly until the upper and lower envelope symmetrizing with an axis of time.

In sum, the method of EMD is a self-adaptive modal decomposition method. A time sequence signal is decomposed to a plurality of intrinsic mode functions in accordance with the dynamic time sequence signal from high disturbance frequency to low disturbance frequency gradually.

This invention discloses a multi-scales intrinsic entropy analysis method that can quantify the entropies on difference time scales for a complex time series. The related field personnel may establish a standard reference according to the performance of the inherent entropies with different time scales of complex systems, and further to determine the reference of the dynamic and detailed characteristics of the system.

### SUMMARY OF THE INVENTION

A multi-scales intrinsic entropy analysis method of the invention is used to analyze performance of the dynamic characteristics of complex systems, and the steps are as follows:

Step A. A time sequence signal of a system is received. The system is a nonlinear and non-stationary time series dynamic system. The time sequence signal is decomposed to a plurality of intrinsic mode functions (IMF) by a nonlinear and non-stationary mode decomposing method. The nonlinear and non-stationary mode decomposing method is Empirical Mode Decomposition (EMD) method.

The intrinsic mode functions (IMF) are time sequence functions. The average period of the intrinsic mode functions represents the intrinsic time scale of the intrinsic mode functions. The average period of the intrinsic mode functions are the first intrinsic time scale, the second intrinsic time scale until the (n−1)-th intrinsic time scale and the n-th intrinsic time scale in an ascending order. The combination of the intrinsic mode functions can represent the time sequence signals of combining with nonlinear and non-stationary of the different time sequences.

Step B. A first time sequence is selected. The first time sequence is the intrinsic mode function of the first intrinsic time scale. The first time sequence is coarse-granulated via a plurality of coarse-graining scales to generate a first coarse-graining time sequence set. The entropies of the set of coarse-grained time sequences are the complexity distribution of the system.

Step C. The first coarse-graining time sequence set is calculated via an entropy analyzing method to generate a plurality of entropies of the first coarse-graining time sequence set. The maximum of the entropies of the first coarse-graining time sequence set is selected as the first inherent entropy of the first intrinsic time scale. The entropy analyzing method is a sample entropy method.

Step D. The n-th time sequence is selected. The n-th time sequence is a composition of the intrinsic mode functions from the first intrinsic time scale to the n-th intrinsic time scale. The standard deviation of the n-th time sequence is used in the entropy calculation to generate a plurality of entropies of the n-th coarse-graining time sequence set.

Step E. The entropies of the (n−1)-th coarse-graining time sequence set are calculated using the same standard deviation of the n-th time sequence. The plurality of the (n−1)-th coarse-graining time sequence are subtracted from the entropies of the n-th coarse-graining time sequence set to get a plurality of entropy difference values, and the maximum of the entropy difference values is selected as the n-th inherent entropy of the n-th intrinsic time scale.

Step F. A plurality of time sequences are selected to execute Step D. to Step E. to generate the inherent entropies of the second intrinsic time scale, the third intrinsic time scale until the (n−1)-th intrinsic time scale and the n-th intrinsic time scale.

Step G. The inherent entropies of the second intrinsic time scale, the third intrinsic time scale until the (n−1)-th intrinsic time scale and the n-th intrinsic time scale are defined as an inherent entropy set which comprises the intrinsic time scales of the time sequence signal and the inherent entropies of the intrinsic time scales. The inherent entropy set is used to be compared references of a database, and further to generate a figuration with inherent entropy features.

### BRIEF DESCRIPTION OF THE DRAWINGS

FIG. 1 is a flow chart showing the steps of the multi-scales intrinsic entropy analysis method in the invention.

FIG. 2 shows information of intrinsic mode functions.

FIG. 3 shows information of the coarse-graining time sequence set derived from the first time sequence.

FIG. 4 shows information of the second time sequence as the combination of the first intrinsic mode function (IMF1) and the second intrinsic mode function (IMF2).

FIG. 5(a)˜(e) shows drawings of entropy distribution varying with intrinsic times scales and coarse-graining time scales for human heartbeat signals.

FIG. 6 shows a drawing of inherent entropies of human heartbeat signals for different groups.

### DETAILED DESCRIPTION OF THE INVENTION

For clarity of disclosure, and not by way of limitation, the detailed description of the invention is divided into the subsections that follow.

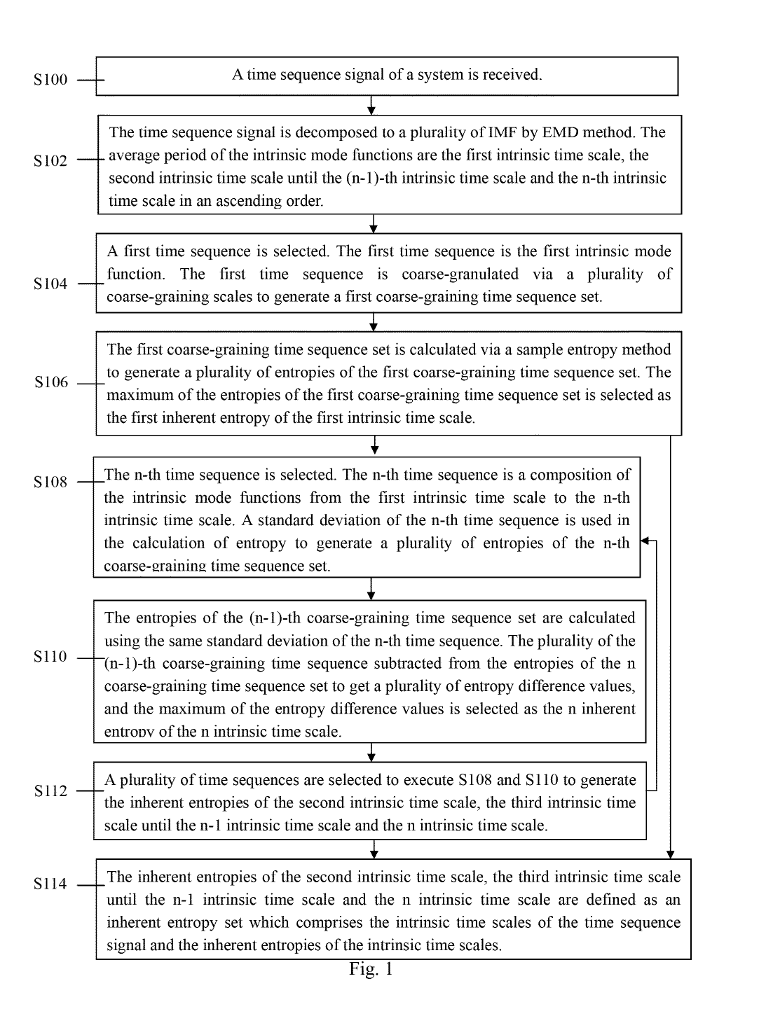

Please refer to FIG. 1, which is a flow chart showing the steps of the multi-scales intrinsic entropy analysis method in the invention. The method of the invention is used to analyze the dynamic characteristics of complex systems, and the steps are as follows:

As shown in Step S100, a time sequence signal of a system is received. In a preferred embodiment, the system is a non-steady-state and nonlinear dynamic system with time sequences. In an embodiment, time sequence signals of a physiological system, an engineering system, an environmental system or any other system can be received by the invention, which is not limited herein.

As shown in Step S102, the time-sequence signal is decomposed to a plurality of intrinsic mode functions by a nonlinear and non-stationary mode decomposing method. Each intrinsic mode function includes an average period, and the average period are the first intrinsic time scale, the second intrinsic time scale until the (n−1)-th intrinsic time scale and the n-th intrinsic time scale in an ascending order. In a preferred embodiment, the nonlinear and non-stationary mode decomposing method is Empirical Mode Decomposition (EMD) method.

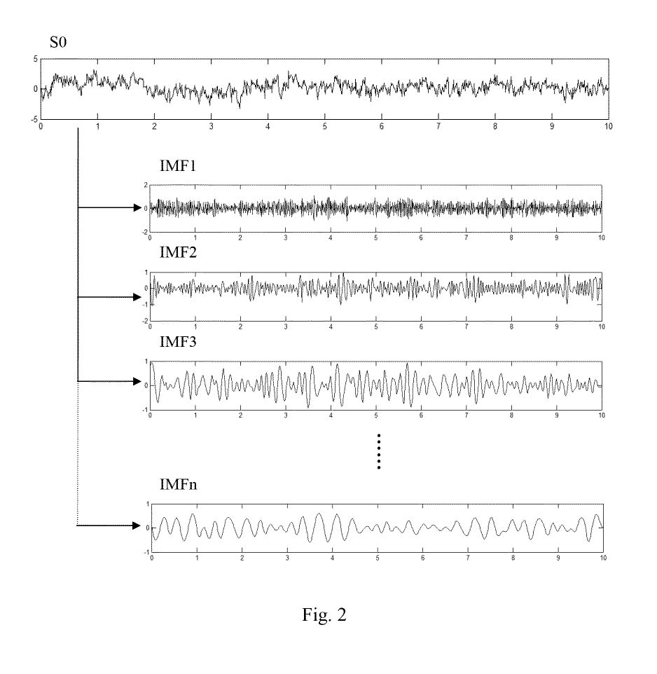

In an embodiment, please refer to FIG. 2 showing information of intrinsic mode functions. A time sequence signal of a physiological system is provided. The time sequence signal is an individual's heartbeat value within 600 seconds (10 minutes), The 600 seconds is decomposed to a plurality of intrinsic mode functions by EMD method.

As shown in Step S104, a first time sequence is selected, the first time sequence is the first intrinsic mode function. The first time sequence is granulated via a plurality of coarse-graining scales to generate a first coarse-graining time sequence set.

As shown in Step S106, the first coarse-graining time sequence set is calculated via an entropy analyzing method to generate a plurality of entropies of the first coarse-graining time sequence set. The maximum of the entropies of the first coarse-graining time sequence set is selected as the first inherent entropy of the first intrinsic time scale. In a preferred embodiment, the entropy analyzing method is a sample entropy method, which is not limited herein.

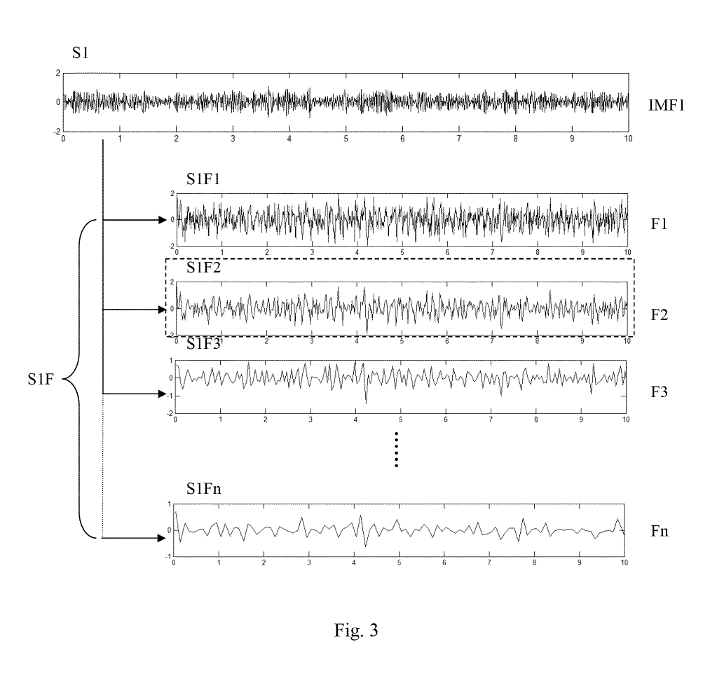

In an embodiment, please refer to FIG. 3 showing information of coarse-graining time sequence sets. The intrinsic mode function of the first intrinsic time scale IMF1 is selected as the first time sequence S1. The first time sequence S1 is granulated via a plurality of coarse-graining scales (F1, F2, . . . , Fn) to generate a first coarse-graining time sequence set (S1F1, S1F2, . . . , S1Fn). Then, the first coarse-graining time sequence set is calculated via the entropy analyzing method to generate a plurality of entropies of the first coarse-graining time sequence set. If the entropy of the second coarse-graining time sequence S1 F2 is the maximum of the first coarse-graining time sequence set, the entropy of the second coarse-graining time sequence S1F2 is selected as the first inherent entropy of the first intrinsic time scale. The number of coarse-graining scales (F1, F2, . . . , Fn) is not limited herein.

As shown in Step S108, the n-th time sequence is selected. The n-th time sequence is a composition of the intrinsic mode functions from the first intrinsic time scale to the n-th intrinsic time scale, and a standard deviation of the n-th time sequence is used in the entropy calculation to generate a plurality of entropies of the n-th coarse-graining time sequence set.

As shown in Step S110, the entropies of the (n−1)-th coarse-graining time sequence set are subtracted from the entropies of the n-th coarse-graining time sequence set to get a plurality of entropy difference values of the coarse-graining scales, and the maximum of the entropy difference values is selected as the n-th inherent entropy with the n-th intrinsic time scale.

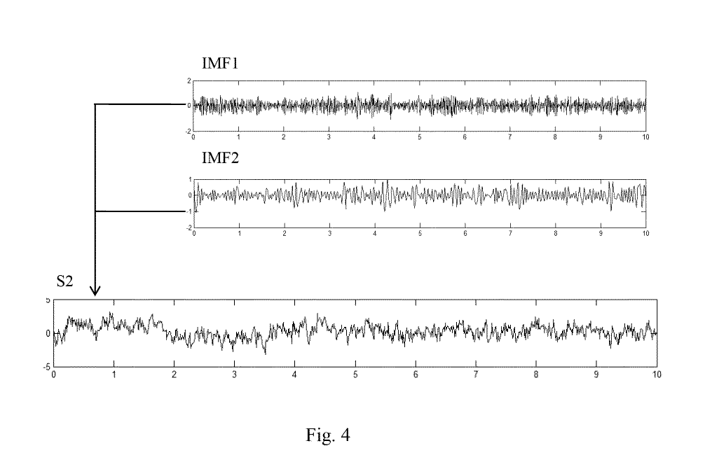

In an embodiment, please refer to FIG. 4, showing information of the first intrinsic time scale IMF1 to the second intrinsic time scale IMF2. The composition of the intrinsic mode functions from the first intrinsic time scale IMF1 to the second intrinsic time scale IMF2 is selected as the second time sequence S2. A standard deviation of the second time sequence S2 is used in the entropy calculations to generate a plurality of entropies of the n-th coarse-graining time sequence set (S2F1, S2F2, . . . , S2Fn). The number of the composition of the intrinsic mode functions and the number of the coarse-graining scales is not limited herein.

Using the same standard deviation of the second time sequence (S2), the entropies of the first coarse-graining time sequence set (S1F1, S1F2, . . . , S1Fn) are subtracted from the entropies of the second coarse-graining time sequence set (S2F1, S2F2, . . . , S2Fn) to get a plurality of entropy difference values (S2D1, S2D2, S2Dn) of the coarse-graining scales (F1, F2, . . . , Fn). If the coarse-graining scale F5 includes the maximum entropy difference value, the entropy difference value S2D5 is selected as the inherent entropy of the second intrinsic time scale.

In an embodiment, the composition of the intrinsic mode functions from the first intrinsic mode function IMF1 to the third intrinsic mode function IMF3 is selected as the third time sequence S3. A standard deviation of the third time sequence S3 is used in the entropy calculations to generate a plurality of entropies of the third coarse-graining time sequence set (S3F1, S3F2, . . . , S3Fn).

Using the same standard deviation of the second time sequence (S3), the entropies of the second coarse-graining time sequence set (S2F1, S2F2, . . . , S2Fn) are subtracted from the entropies of the third coarse-graining time sequence set (S3F1, S3F2, . . . , S3Fn) to get a plurality of entropy difference values (S3D1, S3D2, S3Dn) of the coarse-graining scales (F1, F2, . . . , Fn). If the coarse-graining scale F7 includes the maximum entropy difference value, the entropy difference value S3D7 is selected as the inherent entropy of the third intrinsic time scale.

As shown in Step S112, a plurality of time sequences are selected to execute Step 108. to Step 110. to generate the inherent entropies of the second intrinsic time scale, the third intrinsic time scale until the (n−1)-th intrinsic time scale and the n-th intrinsic time scale.

As shown in Step S114, the inherent entropies of the second intrinsic time scale, the third intrinsic time scale until the (n−1)-th intrinsic time scale and the n-th intrinsic time scale are defined as an inherent entropy set which comprises the intrinsic time scales of the time sequence signal and the inherent entropies of the intrinsic mode functions. The inherent entropy set is used to be compared references of a database, and further to generate a figuration with inherent entropy features.

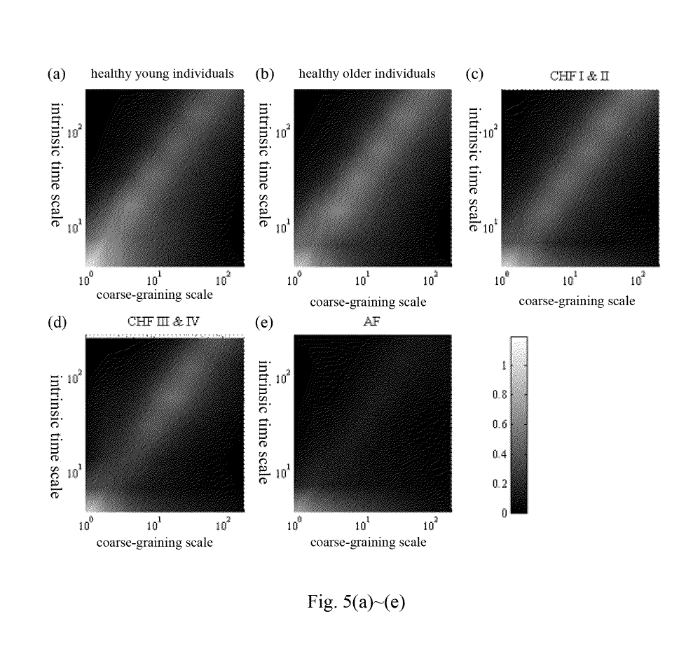

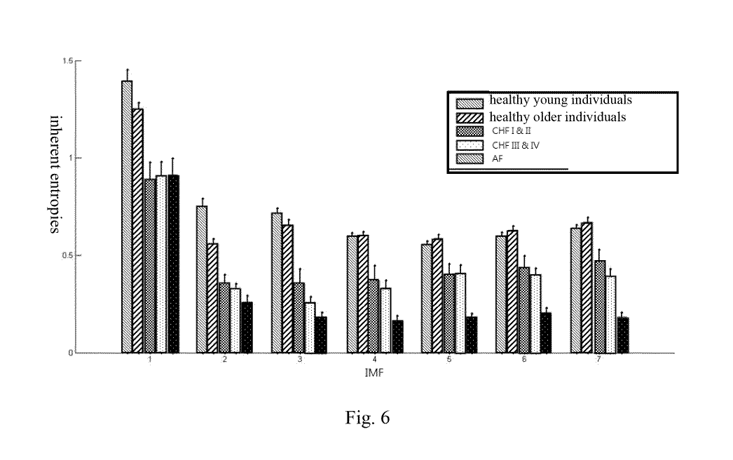

In an embodiment, please refer to FIG. 5(a)˜(e) And FIG. 6, respectively showing drawings of intrinsic time scales and inherent entropies of human heartbeat signals. The drawings show the 141 portfolios of statistics with inherent entropies of human heartbeat signals. Among 141 portfolios, as shown in FIG. 5(a), 44 portfolios are cases of healthy young individuals of 36.39±9.4 years old, and as shown in FIG. 5(b), 28 portfolios are cases of healthy older individuals of 66.2±3.7 years old. As shown in FIG. 5(c), 22 portfolios are cases of minor Congestive Heart Failure (CHF I & H). As shown in FIG. 5(d), 22 portfolios are cases of severe Congestive Heart Failure (CHFIII&IV). As shown in FIG. 5(e), 25 portfolios are cases of Atrial Fibrillation (AF).

The human heartbeat signals show different eigenvalues corresponding to different physiological conditions and pathological characteristics. As shown in FIG. 5(a)˜(e), the y axis represents the time scales of intrinsic mode functions and the x axis represents the coarse-graining scales of intrinsic mode functions. The method of the present invention to resolve the heartbeat signals of these individual cases is that comparing the patients' figurations with inherent entropy features with the normal individuals' figurations with inherent entropy features. It can be found that the performance of each scale tends downward for patients with heart disease, especially in larger time scales, the decreasing trend is more obvious.

Medical personnel can determine disease by comparing features of physiology signals with the database. As shown in FIG. 6, the x axis represents the inherent entropies of references and the y axis represents the inherent entropies of individuals. The inherent entropies show different eigenvalues corresponding to different physiological conditions and pathological characteristics. Medical personnel may establish a standard reference according to the performance of the inherent entropies, and further to determine heart disease.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A method of analyzing inherent entropy in a system, comprising:
Step A. receiving a time sequence signal of the system and decomposing the time sequence signal to a plurality of intrinsic mode functions by a nonlinear and non-stationary mode decomposing method, the average period of the intrinsic mode functions are the first intrinsic time scale, the second intrinsic time scale until the (n−1)-th intrinsic time scale and the n-th intrinsic time scale in an ascending order;
Step B. selecting a first time sequence, which is the intrinsic mode function of the first intrinsic time scale, and coarse-graining the first time sequence via a plurality of coarse-graining scales to generate a first coarse-graining time sequence set;
Step C. calculating the first coarse-graining time sequence set via an entropy analyzing method to generate a plurality of entropies of the first coarse-graining time sequence set, and selecting the maximum of the entropies of the first coarse-graining time sequence set as the first inherent entropy of the first intrinsic time scale;
Step D. selecting the n-th time sequence, which is a composition of the intrinsic mode functions from the first intrinsic time scale to the n-th intrinsic time scale, and providing a standard deviation of the n-th time sequence in the entropy calculations to generate a plurality of entropies of the n coarse-graining time sequence set;
Step E. subtracting the entropies of the (n−1)-th coarse-graining time sequence set from the entropies of the n-th coarse-graining time sequence set to get a plurality of entropy difference values, and selecting the maximum of the entropy difference values as the n-th inherent entropy of the n-th intrinsic time scale;
Step F. selecting a plurality of time sequences to execute Step D. to Step E. to generate the inherent entropies of the second intrinsic time scale, the third intrinsic time scale until the (n−1)-th intrinsic time scale and the n-th intrinsic time scale; and
Step G the inherent entropies of the second intrinsic time scale, the third intrinsic time scale until the (n−1)-th intrinsic time scale and the n-th intrinsic time scale are defined as an inherent entropy set which comprises the intrinsic time scales of the time sequence signal and the inherent entropies of the intrinsic time scales.

2. The method of analyzing inherent entropy in a system according to claim 1, wherein Step G comprises a method to generate a figuration with inherent entropy features.

3. The method of analyzing inherent entropy in a system according to claim 2, wherein Step G comprises a method to compare the figuration with inherent entropy features with a database.

4. The method of analyzing inherent entropy in a system according to claim 1, wherein the system is a non-steady-state and nonlinear dynamic system with time sequences.

5. The method of analyzing inherent entropy in a system according to claim 1, wherein the nonlinear and non-stationary mode decomposing method is Empirical Mode Decomposition (EMD) method.

6. The method of analyzing inherent entropy in a system according to claim 1, wherein the entropy analyzing method is a sample entropy method.
